(19) United States
(12) Patent Application Publication
(10) Pub. No.: US 2005/0202390 A1
(43) Pub. Date: Sep. 15, 2005

(54) COURSE EVALUATION SURVEY MANAGEMENT AND REPORTING SYSTEM AND METHOD

(76) Inventors: J. Vance Allen, Denver, CO (US); Brian Burson, Highlands Ranch, CO (US); Kevin Hoffman, Englewood, CO (US); Scott Lewis, Littleton, CO (US); Sean McCormick, Highlands Ranch, CO (US); Mark Resmer, Larkspur, CO (US)

Correspondence Address: SNELL & WILMER;ONE ARIZONA CENTER, 400 EAST VAN BUREN, PHOENIX, AZ, 850040001, US

(21) Appl. No.: 10/905,862

(22) Filed: Jan. 24, 2005

Related U.S. Application Data
(60) Provisional application No. 60/539,047, filed on Jan. 23, 2004.

(51) Int. Cl. G09B 7/00

(52) U.S. Cl. 434/353

(57) ABSTRACT

The invention provides for automatic deployment, logging, and reporting of online course evaluations based on processing and access schedules and user access designations established by administrators at the time the evaluation survey is generated. Evaluation reports are automatically delayed until student final grades are submitted. Report notifications are sent via email to appropriate faculty and administration including a link or an encrypted link to access the reports.

### FIELD OF INVENTION

The invention generally relates to management and reporting of course evaluations for online educational courses.

### BACKGROUND OF INVENTION

An increasing number of institutions are offering online educational courses (known as “eLearning” courses). For example, many traditional higher learning institutions are adding online courses and mixed classroom/online courses to their course offerings. Other institutions exist only in the online environment. Student evaluations of the various courses, instructors, and online learning experience play an important part in improving and administering such courses.

Conventional student evaluations typically include a series of questions distributed to students requesting either multiple choice selections or short answers concerning different aspects of the course experience, e.g., adequacy of written materials, instructor preparation, etc. More advanced online surveys may enable students to respond to a survey email or to a survey hosted on a course related web page.

Many existing online course survey systems require faculty or staff to create and deploy individual course specific surveys and to then compile and/or log student responses. The compiled evaluation data is then accessible to faculty, administrators, and staff for generating various reports. However, these existing systems do not provide a sufficient means for logging all survey data prior to an instructor's submission of student's final grades at the end of the courses, while providing instructors access to such data only after grades have been submitted. The inherent danger of such systems is that grades and students' candor in surveys could possibly be affected by the instructor having access to such data before submitting grades. Existing systems also provide limited, if any, systems and methods for assigning varying access levels to such data based on different system user roles.

Existing evaluation methods and systems often require that a user request a report of compiled data only after such data is collected. In this system, hundreds, and in many cases, thousands of individual course evaluation reports must be individually requested, individually processed, and individually reported by staff members in a short time frame. These methods and systems typically require a significant number of work hours beyond generating and deploying such surveys. Moreover, since evaluation processing is often required for numerous courses at the same time, processing systems are frequently backlogged and often crash, necessitating even more redundant work hours to resubmit evaluation report processing requests. Staff must then manually notify appropriate faculty and administration when each report is available. Existing systems also lack any automated notification mechanism for alerting users when survey reports are available.

Accordingly, there is a need for an online course evaluation method and system that provides for automatic processing and reporting of student evaluation surveys with increased security and efficiency, and that overcomes these and other shortcomings of the prior art.

### SUMMARY OF INVENTION

In general, the invention provides automated student evaluation survey reporting to faculty and administration according to schedules and parameters established, for example, at the time the survey is first deployed. The invention enables administrators to retain increased control over the timing and distribution of reports. For example, during creation of a particular survey, a survey administrator may specify a processing date and a subsequent delayed faculty access date to allow for timely processing of evaluations while withholding access to faculty until final grades have been submitted. The invention includes an asynchronous reporting feature that allows survey reports to be generated on a predetermined date and to be made available for viewing by faculty and administrators on a predetermined subsequent date. This asynchronous reporting feature also allows administrators to better balance the processing loads for numerous evaluation batches, while substantially ensuring timely delivery of reports. Asynchronous reporting also enables administrators to timely process student evaluation surveys, yet withhold survey reports until final semester grades have been submitted.

Notification to report recipients is provided, for example, in an email including a link to a log-in page to access reports, or including an encrypted direct link to a secure page displaying the corresponding reports. Administrators may assign various roles to users with access to reports generated for various courses or at various node levels being preconditioned on designated user and role type authorizations. Survey administrators may also set any number of calendar events or dates associated with a report to be generated. For example, in one embodiment, the system prompts the administrator to enter a report generation date, a start “access date,” and an optional end “access date.”

### BRIEF DESCRIPTION OF THE DRAWINGS

Additional aspects of the invention will become evident upon reviewing the non-limiting embodiments described in the specification and the claims taken in conjunction with the accompanying figures, wherein like reference numerals denote like elements, and

FIG. 1 is a block diagram illustrating an exemplary system according to one embodiment of the invention; and

FIG. 2 is a flowchart illustrating an exemplary course evaluation and survey reporting process according to one embodiment of the invention.

### DETAILED DESCRIPTION

The detailed description of exemplary embodiments of the invention herein makes reference to the accompanying drawings, which show the exemplary embodiment by way of illustration and its best mode. While these exemplary embodiments are described in sufficient detail to enable those skilled in the art to practice the invention, it should be understood that other embodiments may be realized and that logical and mechanical changes may be made without departing from the spirit and scope of the invention. Thus, the detailed description herein is presented for purposes of illustration only and not of limitation. For example, the steps recited in any of the method or process descriptions may be executed in any order and are not limited to the order presented.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

The survey reporting system is configured, in one embodiment, to allow faculty and administrators to conveniently create multiple course-level survey reports, to share those reports with other users in a system, and/or to reduce wait/lag time associated with high volume or large batch processing and reporting. More specifically, the exemplary reporting system is asynchronous and allows survey administrators to populate a “view reports” web-page for instructors and/or administrators with summary or detailed survey reports that are automatically generated and viewable at different designated dates, times, intervals or other time periods. With asynchronous population of such reports, instructors and administrators may view generated reports without the lag time associated with conventional processing and delivering of reports. In one embodiment, “asynchronous” reporting includes a survey processing or report generation date which is different than an access or access notification date.

In one exemplary asynchronous reporting scenario, a survey administrator selects a particular type of report to be generated and enables an asynchronous reporting feature. The system prompts the survey administrator to set a faculty and/or administrator access date for the report and to add any additional report recipients. The system automatically submits the report for processing at least twenty-four hours before the access date. An electronic message (e.g., email, pager, cell phone) is sent to all users associated with a given report, including a hyperlink or URL to the report stored on the system.

In one embodiment, the invention provides both automated and manual survey reporting features. Using the automated features, survey administrators may establish all (or any portion of) processing and reporting settings simultaneously with survey generation and deployment. Using the manual features, survey administrators or other users may at any appropriate time request that a survey report be generated. Users may also choose to manually access a survey report wizard to view the generated reports.

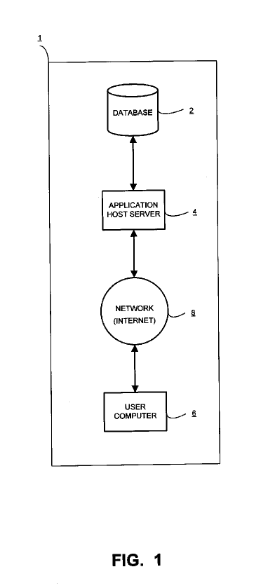

Turning to the drawings, FIG. 1 illustrates an exemplary course evaluation management system 1 including a database 2, host server 4, and a user computer 6 communicating with host server 4 over a network 8. In this embodiment, host server 4 includes a course evaluation survey management and reporting software application accessible by any user computer 6 with access to network 8. Database 2 stores data including surveys, survey responses, distribution lists and any other relevant data. Asynchronous reporting may be performed using multiple databases 2 and/or host servers 4 to facilitate load balancing during end of semester peak processing times.

Host server 4 may include any number of software applications. Exemplary applications include a course evaluation survey management application for creating and deploying surveys and for receiving and logging student responses; an email engine for distributing and gathering survey and report information (e.g., delivering surveys to students, gathering survey responses, and delivering survey reports to faculty and administrators); and a survey report wizard for generating reports and submitting reports for processing, updating and distribution.

In an exemplary use case, a survey administrator logs in to system 1 with user computer 6 and generates a series of course evaluation questions to be presented to students at the end of a course. The series of questions is then stored or logged in database 2. System 1 then presents the series of questions stored in database 2 to students over various user computers 6. For example, students may respond to a survey email or may be required to login at a system web-site to access and respond to the evaluation survey questions. Student may also print the survey and complete it manually for entry back into the system by a third person. Student responses are transmitted from user computer 6 to host server 4 and logged or stored in database 2. At a predetermined issue/processing time, host server 4 retrieves batches of stored student survey response data from database 2 and processes the data to generate reports to be accessed by predetermined users through various user computers 6. At a predetermined user access time, host server 4 generates and delivers an electronic message to various user computers 6 providing notification of availability of reports to the predetermined users. The message includes a hyperlink to a report which may be located on a web-site hosted on host server 4. Selection or activation of a link in a message on user computer 6 accesses the “view reports” website. In an exemplary embodiment, the link is encrypted and includes user login credentials or other authentication data, enabling direct, authenticated report viewing on the web-page. If the link does not include encrypted user login credentials, the user is prompted to enter authenticating information to view the reports.

The various system components discussed herein may include one or more of the following: a host server or other computing systems including a processor for processing digital data; a memory coupled to the processor for storing digital data; an input digitizer coupled to the processor for inputting digital data; an application program stored in the memory and accessible by the processor for directing processing of digital data by the processor; a display device coupled to the processor and memory for displaying information derived from digital data processed by the processor; and a plurality of databases. Database 2 or other databases used herein may include: course data; survey data; student data; institution data; and/or like data useful in the operation of the present invention. As those skilled in the art will appreciate, user computer 6 may include an operating system (e.g., Windows NT, 95/98/2000, OS2, UNIX, Linux, Solaris, MacOS, etc.) as well as various conventional support software and drivers typically associated with computers. User computer 6 may include any suitable personal computer, network computer, workstation, minicomputer, mainframe or the like. User computer 6 can be in a home or educational institution environment with access to network 8. In an exemplary embodiment, access through network 8 is through the Internet through a commercially-available web-browser software package.

As used herein, the term “network” shall include any electronic communications means which incorporates both hardware and software components of such. Communication among the parties in accordance with the present invention may be accomplished through any suitable communication channels, such as, for example, a telephone network, an extranet, an intranet, Internet, point of interaction device (personal digital assistant (e.g., Palm Pilot®), cellular phone, kiosk, etc.), online communications, satellite communications, off-line communications, wireless communications, transponder communications, local area network (LAN), wide area network (WAN), networked or linked devices, keyboard, mouse and/or any suitable communication or data input modality. The invention may be implemented with TCP/IP communications protocols or with IPX, Appletalk, IP-6, NetBIOS, OSI or any number of existing or future protocols. If network 8 is in the nature of a public network, such as the Internet, it may be advantageous to presume the network to be insecure and open to eavesdroppers. Specific information related to the protocols, standards, and application software utilized in connection with the Internet is generally known to those skilled in the art and, as such, need not be detailed herein. See, for example, DILIP NAIK, INTERNET STANDARDS AND PROTOCOLS (1998); JAVA 2 COMPLETE, various authors, (Sybex 1999); DEBORAH RAY AND ERIC RAY, MASTERING HTML 4.0 (1997); and LOSHIN, TCP/IP CLEARLY EXPLAINED (1997) and DAVID GOURLEY AND BRIAN TOTTY, HTTP, THE DEFINITIVE GUIDE (2002), the contents of which are hereby incorporated by reference.

The various system components may be independently, separately or collectively suitably coupled to network 8 via data links which includes, for example, a connection to an Internet Service Provider (ISP) over the local loop as is typically used in connection with standard modem communication, cable modem, Dish networks, ISDN, Digital Subscriber Line (DSL), or various wireless communication methods, see, e.g., GILBERT HELD, UNDERSTANDING DATA COMMUNICATIONS (1996), which is hereby incorporated by reference. It is noted that network 8 may be implemented as other types of networks, such as an interactive television (ITV) network. Moreover, the system contemplates the use, access, viewing, copying, sale or distribution of any information, goods or services over any network having similar functionality described herein.

As used herein, “transmit” may include sending electronic data from one system component to another over a network connection. Additionally, as used herein, “data” may include encompassing information such as commands, queries, files, data for storage, and the like in digital or any other form.

The invention contemplates uses in association with web services, utility computing, pervasive and individualized computing, security and identity solutions, autonomic computing, commodity computing, mobility and wireless solutions, open source, biometrics, grid computing and/or mesh computing.

Database 2 or any other databases discussed herein may include relational, hierarchical, graphical, or object-oriented structure and/or any other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, using a key field in the tables to speed searches, sequential searches through all the tables and files, sorting records in the file according to a known order to simplify lookup, and/or the like. The association step may be accomplished by a database merge function, for example, using a “key field” in pre-selected databases or data sectors.

More particularly, a “key field” partitions database 2 according to the high-level class of objects defined by the key field. For example, certain types of data may be designated as a key field in a plurality of related data tables and the data tables may then be linked on the basis of the type of data in the key field. The data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); Binary Large Object (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a BLOB. Thus, any binary information can be stored in a storage space associated with a data set. The BLOB method may store data sets as ungrouped data elements formatted as a block of binary via a fixed memory offset using either fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first party, a second data set which may be stored may be provided by an unrelated second party, and yet a third data set which may be stored, may be provided by a third party unrelated to the first and second party. Each of these three exemplary data sets may contain different information that is stored using different data storage formats and/or techniques. Further, each data set may contain subsets of data that also may be distinct from other subsets.

As stated above, in various embodiments of the present invention, the data can be stored without regard to a common format. However, in one exemplary embodiment of the present invention, the data set (e.g., BLOB) may be annotated in a standard manner when provided for manipulating the data. The annotation may comprise a short header, trailer, or other appropriate indicator related to each data set that is configured to convey information useful in managing the various data sets. For example, the annotation may be called a “condition header”, “header”, “trailer”, or “status”, herein, and may comprise an indication of the status of the data set or may include an identifier correlated to a specific issuer or owner of the data. In one example, the first three bytes of each data set BLOB may be configured or configurable to indicate the status of that particular data set; e.g., LOADED, INITIALIZED, READY, BLOCKED, REMOVABLE, or DELETED.

The data set annotation may also be used for other types of status information as well as various other purposes. For example, the data set annotation may include security information establishing access levels. The access levels may, for example, be configured to permit only certain individuals, levels of employees, companies, or other entities to access data sets, or to permit access to specific data sets. Furthermore, the security information may restrict/permit only certain actions such as accessing, copying, modifying, and/or deleting data sets. In one example, the data set annotation indicates that only the data set owner or the user are permitted to delete a data set, various identified users may be permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

User computer 6 may be further equipped with an Internet browser connected to the Internet or an intranet using standard dial-up, cable, DSL or any other Internet protocol known in the art. Transactions originating at a web client may pass through a firewall in order to prevent unauthorized access from users of other networks. Further, additional firewalls may be deployed between the varying system components to further enhance security.

A firewall may include any hardware and/or software suitably configured to protect system components and/or enterprise computing resources from users of other networks. Further, a firewall may be configured to limit or restrict access to various systems and components behind the firewall for web clients connecting through a web server. The firewall may reside in varying configurations including Stateful Inspection, Proxy based and Packet Filtering among others. The firewall may be integrated within a web server or any other system components or may further reside as a separate entity.

The computers discussed herein may provide a suitable website or other Internet-based graphical user interface which is accessible by users. In one embodiment, the Microsoft Internet Information Server (IIS), Microsoft Transaction Server (MTS), and Microsoft SQL Server, are used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), helper applications, plug-ins, and the like. A server may include a web service that receives a request from a web server, the request including a URL (http://yahoo.com/stockquotes/ge) and an IP address (123.56.789). The web server retrieves the appropriate web pages and sends the data or applications for the web pages to the IP address. Web services are applications that are capable of interacting with other applications over a communications means, such as the Internet. Web services are typically based on standards or protocols such as XML, SOAP, WSDL and UDDI. Web services methods are well known in the art, and are covered in many standard texts. See, e.g., ALEX NGHIEM, IT WEB SERVICES: A ROADMAP FOR THE ENTERPRISE (2003), hereby incorporated by reference.

The present invention may be described herein in terms of functional block components, optional selections and various processing steps. It should be appreciated that such functional blocks may be realized by any number of hardware and/or software components configured to perform the specified functions. For example, the present invention may employ various integrated circuit components, e.g., memory elements, processing elements, logic elements, look-up tables, and the like, which may carry out a variety of functions under the control of one or more microprocessors or other control devices. Similarly, the software elements of the present invention may be implemented with any programming or scripting language such as C, C++, Macromedia Cold Fusion, Microsoft Active Server Pages, Java, COBOL, assembler, PERL, Visual Basic, SQL Stored Procedures, extensible markup language (XML), with the various algorithms being implemented with any combination of data structures, objects, processes, routines or other programming elements. Further, it should be noted that the present invention may employ any number of conventional techniques for data transmission, signaling, data processing, network control, and the like. Still further, the invention could be used to detect or prevent security issues with a client-side scripting language, such as JavaScript, VBScript or the like. For a basic introduction of cryptography and network security, see any of the following references: (1) “Applied Cryptography: Protocols, Algorithms, And Source Code In C,” by Bruce Schneier, published by John Wiley & Sons (second edition, 1995); (2) “Java Cryptography” by Jonathan Knudson, published by O'Reilly & Associates (1998); (3) “Cryptography & Network Security: Principles & Practice” by William Stallings, published by Prentice Hall; all of which are hereby incorporated by reference.

As used herein, the term “user”, “administrator”, “instructor” or “institution” may be used interchangeably with each other, and each shall mean any person, entity, machine, hardware, software or business. Each user or participant is equipped with a computing device in order to interact with the system and facilitate survey generation, deployment, and reporting. Exemplary user computers 6 include personal computers, laptops, notebooks, hand held computers, set-top boxes, cellular telephones, and the like. Applications may be hosted at a computing center such as a main frame computer. The computing center may be implemented in other forms, such as a mini-computer, a PC server, a network of computers located in the same of different geographic locations, or the like. Moreover, the system contemplates the use or distribution of any goods, services or information over any network having similar functionality described herein

In an exemplary embodiment, survey management system 1 is implemented as computer software modules loaded onto a client computer and a host computing center. Alternatively, the client computer may not require any additional software to support use of the survey management and reporting system. As will be appreciated by one of ordinary skill in the art, the present invention may be embodied as a customization of an existing system, an add-on product, upgraded software, a stand alone system, a distributed system, a method, a data processing system, a device for data processing, and/or a computer program product. Accordingly, the present invention may take the form of an entirely software embodiment, an entirely hardware embodiment, or an embodiment combining aspects of both software and hardware. Furthermore, the present invention may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The present invention is described herein with reference to illustrations of methods, apparatus (e.g., systems), and computer program products according to various aspects of the invention. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, web pages, websites, web forms, prompts, etc. Practitioners will appreciate that the illustrated steps described herein may comprise in any number of configurations including the use of windows, web pages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

In one embodiment, system 1 includes various access points or various user interfaces such as administrator, instructor, or other user web-pages. Course evaluation data and reports may be indexed or displayed on a “view reports” page. In an exemplary embodiment of the invention, the system interface displays a series of semester dropdown menus with surveys and reports arranged by course, instructor, semester, node and the like. The user interface displays a list or identifiers for available surveys and reports. Separate user interfaces may be provided for faculty and administrative user reporting. Varying levels of access may be granted a user based on a subscription, administrative authorization, user classification and the like.

System user interfaces may include any conventional web browser application features and menu functions. Any number of features represented by different tabs, list item, links and the like, may be accessible from any number of interactive screens. Various display fields and standard menu or action links may likewise be cross-linked or associated with any displayed information, field, or other links. Entry of information in any of the described fields may be accompanied by a summary or confirmation page. In a web-based application embodiment, the system includes conventional browser and file menu options such as, for example, find, browse, edit, format and view functions. Auto-completion may be enabled for certain fields and defaults for others may be preset or user defined. For example, the current date may be automatically entered in a date field, yet still provide for alteration by a user.

Menu and pull-down lists may contain editing options such as “Delete this Report” or “Update this Report.” Available survey reports may be listed in a drop-down or pull-down menu or as individual selectable tabs or icons. Selection of a survey report returns a list or visualization of all student response data and other information associated with the course evaluation. Tabs, icons, list items, menu items, radio buttons, etc. may be used interchangeably and may appear on more than one screen and may be fully customizable, for example, as to appearance, order, number, title, contents, cross-references, and the like. Any window, screen, or document present on the system may be exported, printed, emailed, or saved. Passwords may be required for access at any given system level or feature providing increased security or privacy. Encryption may also be used to increase security. Any screen may provide links to any number of other interactive screens. Help dialog boxes may be displayed by positioning the mouse over or by selecting a help icon or by clicking help in the menu bar.

Searches for available reports within the “view reports” pages or survey report wizard may be conducted with full or partial field entries, such as the first three letters of a course name or course code. Additional search options or searchable categories may be provided under an “Advanced Search” option including fields for course name, instructor, semester, access date, creation date, or other searchable types of information used in the art.

The system provides for various authorization levels and user role classifications, both as to generating and to accessing reports. Users may be assigned roles or role types, such as, administrator, survey administrator, system administrator, instructor, staff and the like, with corresponding access levels within the system, e.g., authorization to generate, update, view, and delete reports. In one embodiment, survey administrator roles have access to all automated course-level reports generated by other survey administrators for any courses within a predetermined group. Survey administrators may manually add or omit any other user in advance from a given notification or from “view report” page access.

For example, only survey administrators may be allowed to generate and deploy surveys and reports, while other administrators may be allowed only to view certain reports. Instructors or other users may subscribe to or request access to certain reports. In an exemplary embodiment, instructors may view only reports for those courses that they taught, and administrators may only view reports corresponding to a particular course, department, college, instructor, and the like. Course surveys, course survey reports, and/or user access levels to course survey reports may be organized based on any relevant criteria. For example, in an exemplary embodiment, courses, surveys, reports and user access levels are organized into nodes in a tree-style structure. An exemplary node includes all courses within a given major, minor, department, college, campus or institution. Another exemplary node includes all required, elective, and/or prerequisite courses offered at any level in such a hierarchy. A practitioner will appreciate that any number of combinations of nodes may be created by associating data by any shared or otherwise relevant criteria. Accordingly, reports and report recipients may be grouped according to any number of desired characteristics. This node structure enables efficient prioritization of batch processing and reporting of survey reports within a node.

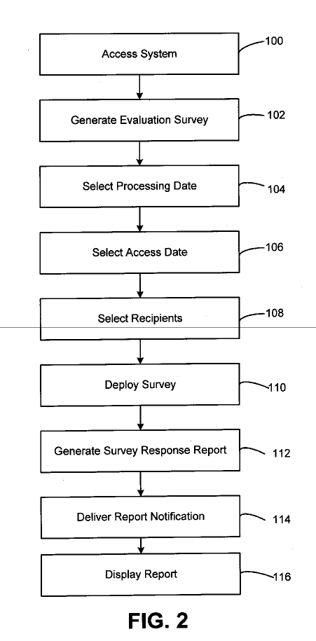

Returning to the figures, FIG. 2 illustrates an exemplary method according to one embodiment of the invention. In general, a user first accesses the system (step 100) by logging in at a secure system web-page. The system verifies entered user login information and displays available application information and features. A user (e.g., survey administrator) may then generate a course evaluation survey (step 102). The survey administrator enters various multiple choice and short answer questions and may designate surveys or individual survey questions as either optional or mandatory.

In one embodiment, survey administrators may select a “faculty” and/or “administrator” automated asynchronous reporting mode for survey reporting. In these modes, survey administrators set the date, time or time frame that faculty and/or administrators are to have access to reports. For example, administrators may be granted access earlier than faculty. Similarly, in another embodiment, the system includes an “instructor” automated reporting mode granting, by default, access to instructors only at the course level, i.e., only for courses that they taught. Additional custom access levels may be manually granted on a group or individual instructor basis. The survey administrator establishes various survey and report access settings and schedules, for example, start and end dates that surveys are available for student input, or that survey reports are available to various users.

The system provides a scheduling feature such as an issue or processing date selection field for the survey administrator to preset the date (step 104) on which student survey responses should be tallied or otherwise processed for reporting. The system may then prompt users to enter an access date that follows the scheduled report generation date. In an alternative embodiment, the report processing date is automatically set to one day or a fixed number of hours prior to a selected access date. For example, the access date that automated surveys are accessible by instructors may be set to one day past the survey end date. The system may require a minimum time between the survey end date and the access date (e.g., If May 1, 2002 is selected to be the survey end date, then the start of the access date range must be set no earlier than May 3, 2002.).

The system provides alerts, prompts, messages and/or any other signal to help users provide appropriate information and choose appropriate settings. For example, an administrator may be prompted in advance to set a processing date that is at least twenty-four hours before the access date to allow adequate processing time in the queue. Alternatively, date selection fields may be continually updated so that available access dates are dependent upon current processing queue schedules or loads. The server may also generate an error message in response to any incorrect or inadequate field entry or selection or when any other required criterion is not met. In this embodiment, the error message is server generated, but other embodiments contemplate error messaging using a JavaScript prompt. An error message is similarly generated in response to tardy setting changes. For example, if a survey administrator changes the processing date after a report has been sent to the queue for processing, an error message indicates that a survey report has already been sent to the queue. Alternatively, the system may present such a message along with an option to continue with the new date and generate a new asynchronous report.

An additional scheduling feature or date selection field allows the survey administrator to preset the access date (step 106) on which reports will be made available to different user role types such as administrators, faculty, instructors, and the like. The system may guide survey administrators in their selection of dates with features such as limited date selection ranges and interactive system messaging. In an exemplary system messaging scenario, an administrator attempts to change the access date for an asynchronous report that has already been queued for processing. The server generates a message indicating that the report has already been sent to the queue for generation and that changing or resetting the access date will result in a redeployment of the asynchronous survey, and further provides options for canceling or continuing the redeployment.

An optional “end access date” feature removes a report from the “view reports” page after a selected date. Alternatively, administrators may not enable the “end access date” feature, leaving each user to delete unwanted and obsolete reports from their own “view reports” pages. Users may delete individual reports related to a course, all reports related to a particular course node, or all available reports from their “view reports” page. Message recipients may request any available updates to the report or may delete report links from their personal page. In one embodiment, administrators may recall incorrect or untimely reports.

Survey administrators can preview a report before the access date by manually generating an instantaneous rather than an asynchronous report, wherein instantaneous includes generation of and access to the report at substantially the same time. Instructors and faculty may also be granted access to run such manual reports in advance of the automated access date. Users may choose not to generate or receive a notification message for reports that are generated manually. Administrators may cancel a report, alter date settings, alter recipient lists and the like at any time prior to the survey data being queued for processing.

The survey administrator then selects an individual recipient or groups of report recipients (step 108) who will have access to the reports on the access date. Survey administrators may select various automated reporting options presented, for example, on a “delivery management” page. Administrator and/or faculty automated reporting may be enabled for any survey at the course level, at the semester level, or at a higher level. For example, in step 108, a survey administrator may select which users or user roles are able to view the resultant report. Administrators, instructors, and other faculty are associated with individual courses or with all courses within a particular node. Survey administrator, instructor and other user names are listed under each node in which they are enrolled. Users may be listed by name, node, course, etc., in a tree or node structure, drop down list, lookup table, or the like. Survey administrators may select users for addition to or deletion from a recipient list for a given report or batch of reports. In one embodiment, system users have the option of subscribing to various course or course node reporting lists.

Administrators may use the survey report wizard to establish repeating automatic or periodic survey reports and to update automated reports accordingly. The system, in one embodiment, assigns names to each course survey and survey report as a function of the course name, semester date, instructor or other relevant course identifier or associated information. A time/date stamp is provided to distinguish between updated or redundant surveys and survey reports for a given course or course node.

The survey administrator also establishes the start and end dates that the survey will be available for input of student responses. The system automatically deploys the survey (step 110) on the survey start date and logs all student responses entered prior to the survey end date.

On the preset issue/processing date, which may coincide with the survey end date, the system automatically generates a report of survey responses (step 112). The step of generating a report includes sending relevant data to a processing queue. In one embodiment, the generated reports may include summaries and/or detailed lists of student responses organized, for example, by question, by qualitative averages for questions of degree, by characterization of responses as favorable or adverse, or by another other statistical analysis method. Administrators or instructors may also generate any number of custom reports from information gathered in response to a deployed survey using a report creation workflow or wizard in a survey management software application hosted on the system.

On the preset access date, the system automatically notifies designated recipients (step 114) that a given survey report or batch of reports is available for viewing. For example, an email notification is sent to faculty at 12:01 AM on the access date. In the event that an access date is equal to, or earlier in time than when a report is completed, the email notifications are sent immediately upon completion of the report. Administrators may select any number of reports for automatic generation and batch notification. A single batch notification email is sent only when all associated reports within an automated report batch have been generated.

Automatic notification is accomplished by an electronic message such as an email listing a single report, associated reports, or all reports that are currently available to a given user for viewing. An exemplary email notification to instructors of generated results includes a subject line, a text box for a message and a URL and/or login link or information associated with data stored in the system. For example, the automatic notification provided in step 114 includes a hyperlink to a web-site displaying the corresponding reports. In an exemplary embodiment, the automatic notification provided in step 114 includes an encrypted URL hyperlink including user authentication data or login credentials such as a user ID and password stored on the system. Activation or selection of the encrypted link thus advances the user directly to the corresponding reports for viewing, without the need to first log in. If an encrypted URL is not included, the email or hyperlink directs faculty to a login page or to the beginning of a survey report wizard application. Successful login advances the user to the corresponding reports.

Email notifications may be set to include information related to a single survey report, to all new survey reports, to all reports currently available to a particular email recipient or to any other subset of reports or portions of reports. Users may have the option to disable email notification for a given report or to unsubscribe from any or all email notifications for a particular course or node. Users who unsubscribe from such notifications may instead view available reports periodically by logging into the view reports page. Survey administrators may select message delivery settings to provide only one email per course, per semester, per course node, per report batch or the like. Similarly, recipients may set their own mail delivery settings accordingly. For example, if an instructor is enrolled in several courses to which automated surveys are sent, the instructor may choose to receive only one email listing all surveys to which they have subscribed or been granted access.

Upon activation of the encrypted link or of an unencrypted link with associated log in steps, the system displays the reports (step 116) corresponding to the activated link. The system may optionally display a full report, summaries of available reports, or merely a list of available reports. The system automatically assigns names to reports as a function of course data such as, for example, course title, semester dates, instructor name, and the like.

The system includes a “view reports” page for each user, displaying a personalized list of courses and/or reports to which a user has subscribed or been granted access by administrators. The “view reports” page includes any user options and file management features available through conventional web-based or email applications. For example, users may open, view, print, move, delete, archive, mark for follow-up, or add comments to any reports presented on a “view reports” page. Reports may be reordered or grouped according to any relevant criteria, including time of receipt, course, node, and the like. System users may also access reports through an automated survey report wizard, without the need for an automated notification or link. An exemplary wizard provides users options or workflow steps including: report creation, view survey report, locate a survey (e.g., by name, date, etc.), course level report, and view all survey questions.

Survey administrators may preset (step 106) or later assign an end access date after which users will no longer be able to view a given report. Users may be granted authority to update automated reports, i.e., to request reprocessing of relevant survey data. In one embodiment, no access end date is associated with an automated report and all hyperlinks remain actively linked to a user's “view reports” page until the user deletes the link manually or updates the report. Alternatively, survey administrators may establish an access end date upon which such automated surveys are no longer associated with the link or accessible on a “view reports” page. In one embodiment, the system or survey administrator is presented the option to update previously sent links to refer to a newly generated report for an earlier survey. In one embodiment, the system is configured to delete a report hyperlink and/or report data upon expiration of a predetermined access period or upon manual deletion. Administrators may be granted greater levels of access or extended access beyond that granted other faculty. For example, in one embodiment, reports remain accessible to administrators even after a report hyperlink has been deleted from faculty “view reports” pages.

Similarly, survey administrators may preset (step 106) or later assign an automatic update date or periodic update schedule. For example, a survey administrator may deploy a survey early in a semester and grant access to various users to monitor student feedback. This is particularly helpful in creating and improving experimental or new courses based on ongoing student feedback.

In one embodiment, the system also allows for “custom reporting” by which an administrator or instructor generates a conventional (i.e. not asynchronous or automatic) report using a survey report wizard application. Users generating custom reports may be allowed to assign a high priority classification to a report, placing it ahead of automated reports in the processing queue. Email notification of custom generated reports is sent once the report has been generated and posted on the system for viewing. The survey report wizard includes screens or pages for faculty and administrators to view custom and/or automated reports.

A survey report wizard application and workflow may be used for automated or custom reporting. In one survey report wizard embodiment, administrators are classified as at least one of a survey administrator and a survey report wizard administrator. Survey administrators have authorization to deploy surveys but no authorization to access results in the survey report wizard. Conversely, survey report wizard administrators are authorized to access automated reports, but not to deploy them. Report recipients may receive an initial message indicating that they have been granted access to the survey report wizard and another email indicating when reports are then available for viewing. A system user having multiple authorizations or classifications may choose not to receive separate duplicate emails for each survey report.

Any number of additional data management features, now known or later developed, may be incorporated into the present system without departing from the invention as described herein. Benefits, other advantages, and solutions to problems have been described herein with regard to specific embodiments. However, the benefits, advantages, solutions to problems, and any element(s) that may cause any benefit, advantage, or solution to occur or become more pronounced are not to be construed as critical, required, or essential features or elements of any or all the claims or the invention.

1. An online course evaluation management and reporting system comprising:
a database having course evaluation data stored thereon; and
a host computer in communication with said database, said host computer configured to automatically generate reports from said course evaluation data on a first predetermined date and to automatically allow access to said reports to predetermined authorized users on a subsequent second predetermined date.

2. The system of claim 1, wherein said host computer is further configured to allow substantially simultaneous selection of said first predetermined date and said subsequent second predetermined date.

3. The system of claim 1, wherein said database includes user access authorization data, said data identifying said predetermined authorized users to be allowed access to said reports generated by said host computer.

4. The system of claim 1, wherein said host computer is configured to automatically provide notification to said predetermined authorized users regarding said access to said reports.

5. The system of claim 4, wherein said notification provided to said predetermined authorized users by said host computer includes an electronic link for directing recipients to a web-page for viewing said reports.

6. The system of claim 5, wherein said electronic link is encrypted and includes user authentication data to provide said predetermined authorized users direct, authenticated access to said web-page for viewing said reports.

7. The system of claim 1, wherein said host computer is further configured to restrict selection of said subsequent second predetermined date to follow at least one of a final grade submission deadline and a confirmation of submission of final grades.

8. The system of claim 1, wherein said host computer is configured to automatically allow access to said reports to predetermined authorized users based on at least one of user role type data, course node data, and institution node data stored on said database.

9. A method for facilitating management of online course evaluations comprising:
generating an electronic student course survey;
preselecting a survey report processing date, a user access date and an authorized report recipient;
presenting said electronic student course survey to at least one student; compiling student responses into an evaluation report based upon said survey report processing date; and,
reporting said evaluation report to said authorized report recipient based upon said user access date.

10. A machine-readable medium having stored thereon a plurality of instructions, said plurality of instructions when executed by a processor, cause said processor to perform a method comprising the steps of:
generating an electronic student course survey;
preselecting a processing date, a user access date and an authorized report recipient;
presenting said electronic student course survey to at least one student;
compiling student responses into an evaluation report based upon said survey report processing date; and,
reporting said evaluation report to said authorized report recipient based upon said user access date.
